(19) United States
(12) Patent Application Publication
(10) Pub. No.: US 2002/0087453 A1
(43) Pub. Date: Jul. 4, 2002

(54) Trading system with anonymous rating of participants

(76) Inventors: Royce Arne Nicolaisen, Orinda, CA (US); Brian Patrick Tormey, Carmichael, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/753,787

(22) Filed: Jan. 2, 2001

(51) Int. Cl. G06F 17/60

(52) U.S. Cl. 705/37

(57) ABSTRACT

A method and apparatus for the analysis and dissemination of data in an on-line trading environment is disclosed. The trading environment is implemented on a server such that users have easy access to an electronic trading exchange via the Internet. A user may set account preferences such that a table is generated and displayed for easy recognition of preferred, acceptable and unacceptable trading partners. In addition, the identity of all sellers may remain unknown to protect the integrity of the trading environment.

### BACKGROUND OF THE INVENTION

1. Field of the Invention

The present invention relates generally to an on-line trading environment. More particularly, the present invention pertains to a system and method for controlling the dissemination and analysis of data for buying and selling commodities in an on-line trading environment wherein the identity of a seller remains anonymous until the terms of the exchange are mutually agreeable.

2. Description of the Related Art

The emergence of on-line auction/trading sites has made it easier to buy and sell products in a convenient, reasonably safe and controlled environment. Currently, everything from consumer electronics to industrial raw materials such as plastic, steel and coal can be traded on-line over the Internet. The popularity and rapid growth rate of the Internet trading community has further accelerated the demand for additional avenues of electronic commerce for items conventionally traded outside the on-line environment.

At present, there are two common forms of on-line trading models available over the Internet. In one model, buyers and sellers are fully aware of each other's identity and buying/selling characteristics. This information is significant to each party to a transaction for many type of products where quality and repeat business are important issues, such as consumer products. At present, this form of trading is the most common and widely used of the on-line trading models. For this model, a seller knows the identity and purchasing characteristics of a potential buyer. This flow of information helps regulate the buyer's conduct through the seller's own dealings and the comments of other sellers that have dealt with the buyer on other occasions. Further, a prospective buyer knows the identity and characteristics of a seller. In this regard, a buyer can be confident of the reputation of the seller and the quality of the product being purchased. This flow of information helps regulate the actions of sellers. As a result, an open trading environment is created, in part by the extensive dissemination of information about both sellers and buyers.

In a second model, there is little if any information exchanged regarding the identity and characteristics of either the buyer or the seller. Under this model, sellers are assured of getting money for their product, so the identity of the buyer is irrelevant. In addition, buyers are unconcerned with the quality of the product they are purchasing, so the identity of the seller is equally unimportant. The traditional securities trading model is an example of this kind of on-line trading environment. Although it is available, information does not flow between buyers and sellers regarding respective buying and selling characteristics, since it is unnecessary to facilitate transactions in this type of trading environment.

While both methods provide a sound trading environment for the respective products, both have the disadvantage of potentially allowing the manipulation of the respective trading markets. Moreover, if either example were modified to remove the identity of the seller, neither would allow for any method for a trader to identify and trade with acceptable trading partners. Further, neither model currently provides preferences and quick displays for easy recognition of acceptable trading partners.

It is therefore desirable to provide a trading model, which displays some characteristics of buyers and sellers but keeps the identity of each anonymous. Under such a model, both a buyer's or a seller's identity is kept secret to prevent market manipulation and to provide a fair, neutral on-line trading location. In addition, it is desirable if the display of trading information is structured such that buyers and sellers can set preferences regarding whom it wishes to trade with and the resulting information was readily displayed in an easy to understand format, without revealing the identity of either the buyer or the seller.

### SUMMARY OF THE INVENTION

The present invention provides a display for the analysis and dissemination of data in an on-line electronic trading exchange provided over the Internet. The electronic trading exchange is configured such that members having accounts can meet and trade commodities in a convenient, accessible and controlled environment. Trading members define account preferences such as payment terms and the trading relationships with other members. When a electronic trading exchange is selected, the account preferences produce a color coded table displaying the various offers to sell and bids to buy. A quick scan of the table indicates which bids or offers are acceptable transactions based upon member defined account preferences. In addition, the coded table indicates which offers and bids should be avoided.

In an alternate embodiment, the present invention is used to maintain the anonymity of buyers and sellers. Maintaining the secrecy of both the buyers' and the sellers' identities helps preserve the integrity of the trading environment.

A further understanding of the nature and advantages of the inventions herein may be realized by reference to the remaining portions of the specification and attached drawings.

### BRIEF DESCRIPTION OF THE DRAWINGS

FIG. 1 is a schematic diagram of a network over which the present invention may be used;

FIG. 2 is a schematic diagram of one embodiment for the accumulation and display of data on an electronic trading exchange;

FIGS. 3-9 are flow charts for the operation for the accumulation and display of data on an electronic trading exchange according to the present invention.

### DESCRIPTION OF THE SPECIFIC EMBODIMENTS

While the present invention is not limited to commodity trading, and more specifically almond trading, the preferred embodiments will be, for the most part, described with reference to almond trading in an on-line trading environment. In addition, one skilled in the art can appreciate that the invention could also be described in conjunction with commodities such as beans, pecans, walnuts, dried fruit, apples, tomatos, rice and juices to name a few.

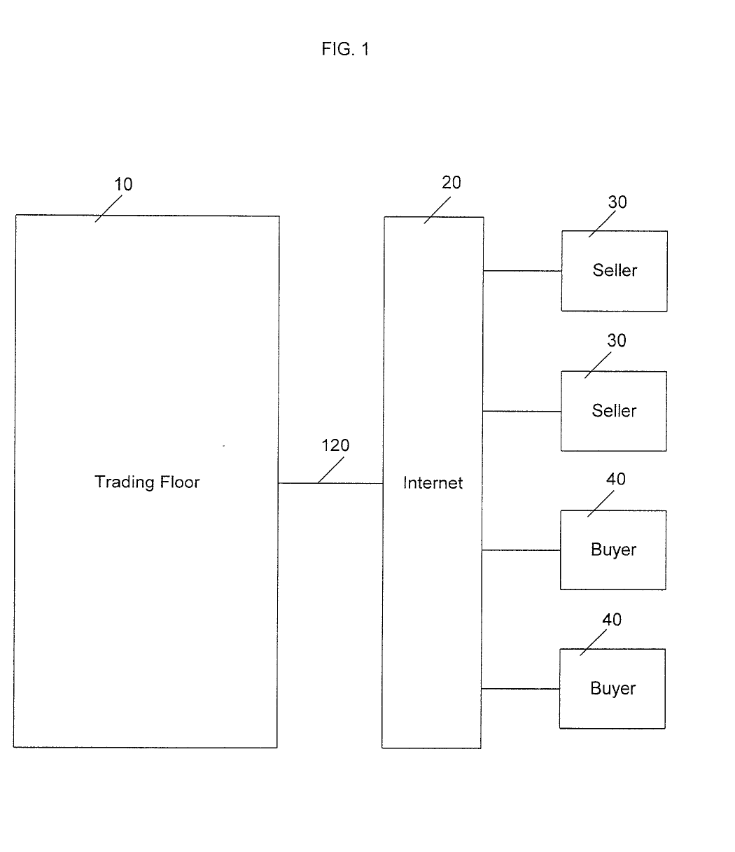

FIG. 1 is a schematic diagram of a network over which the present invention may be used. Electronic trading exchange 10 is connected to the Internet 20 via connection 120. Connection 120 can be any type of connection that is well known in the art and suitable for connecting a server to the Internet. Sellers 30 and buyers 40 connect to the Internet 20 to access electronic trading exchange 10. Sellers 30 can thereafter place offers to sell as well as view bids to buy on electronic trading exchange 10. Moreover, Buyers 40 can place bids to buy as well as view offers to sell on electronic trading exchange 10.

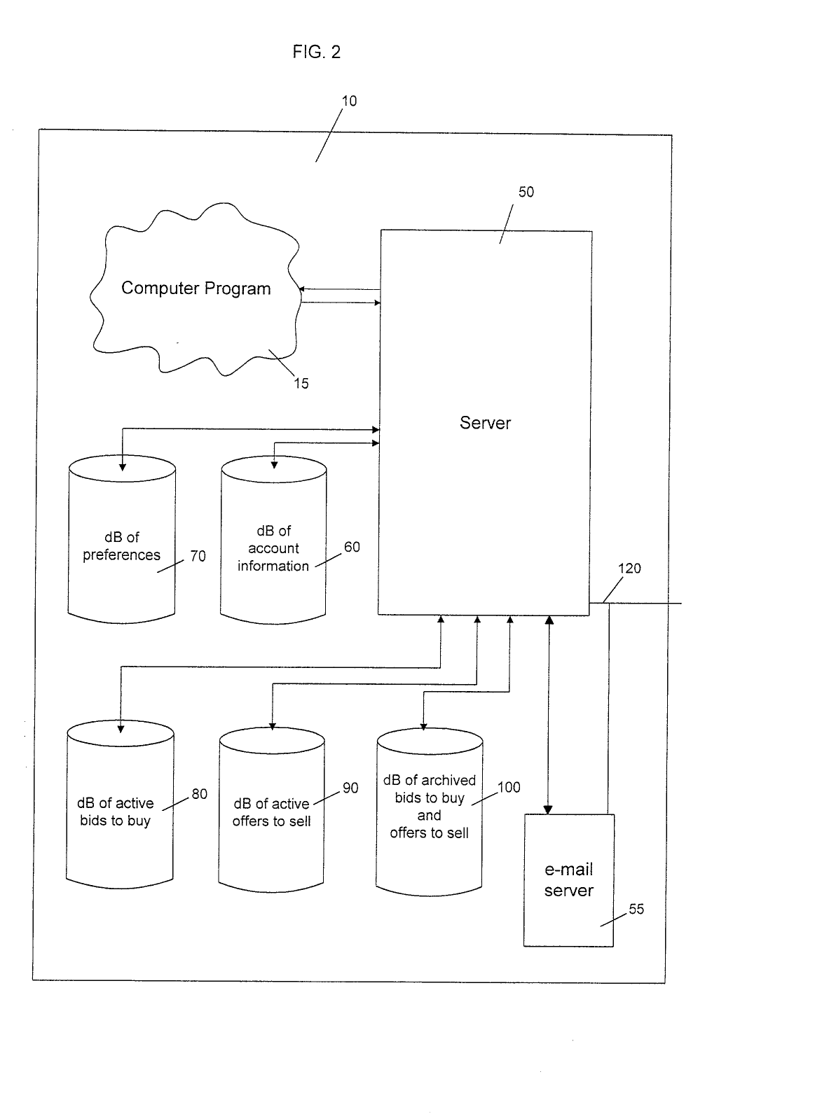

FIG. 2 is a detailed schematic diagram of one embodiment of an electronic trading exchange 10. It should be appreciated by one of ordinary skill in the art that numerous techniques for implementing electronic trading exchange 10 are available, but for sake of brevity only one is illustrated. Server 50 is connected to the Internet 20 via connection 120. As described above, connection 120 can be any connection that is well known in the art suitable for connecting a server to the Internet. Database 60 contains the account information specific to each individual seller 30 and buyer 40 that accesses electronic trading exchange 10. The information a client enters when registering to use electronic trading exchange 10 is stored in database 60, including but not limited to the user's e-mail address, login name, password and company information. Database 70 contains preferences unique to each individual user. Preferences identify other member sellers 30 and buyers 40 that a user designates as preferred trading partners, acceptable trading partners or unacceptable trading partners. In addition, preferences also designate the payment terms for all transactions posted by a user, which a user can customize to each member. Database 80 stores all active bids to buy. Database 90 stores all active offers to sell. Database 100 archives all accepted orders, both offers to sell and bids to buy.

Computer program 15 controls the operation of server 50 such that the information contained in the plurality of databases is presented to sellers 30 and buyers 40 via the Internet 20. Computer program 15 controls how the information is viewed on each member's computer. Specifically, computer program 15 performs the buying, selling and reviewing steps outlined below to control the operation and display of data on electronic trading exchange 10.

E-mail server 55 is connected to server 50 for automatically transmitting information to buyers 40 and sellers 30 in response to specified conditions. Connection 120 couples e-mail server 55 to Internet 20. It should also be appreciated that e-mail server 55 can be incorporated into server 50 instead of residing as a separate entity.

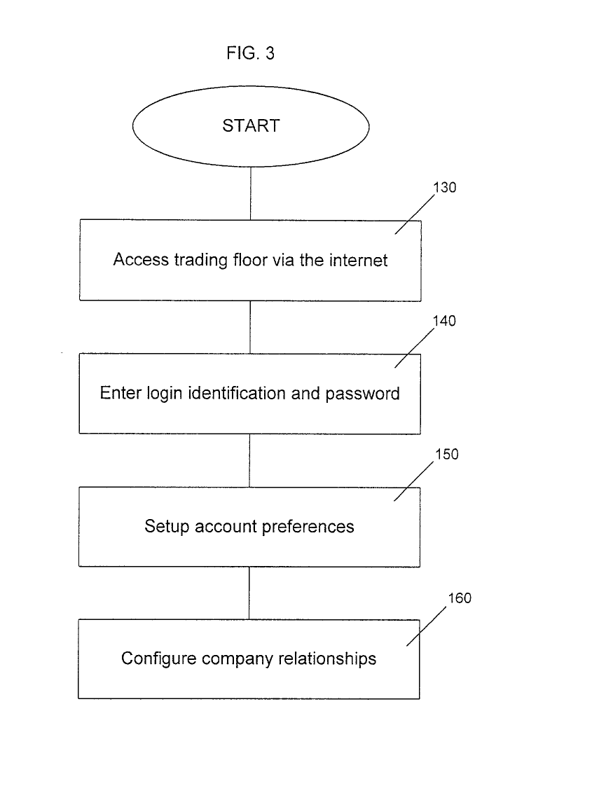

The program according to the present invention will now be described with reference to FIGS. 3-7. FIG. 3 is a flow chart showing the program for the operation of the analysis and dissemination of data on electronic trading exchange 10. Prior to accessing electronic trading exchange 10, the user must register for an account. The registration process can occur either on-line or off-line. FIG. 3 illustrates an on-line log-in and user setup process. Step 130 indicates access to the electronic trading exchange 10 via the Internet 20. As shown in step 140, after gaining access via the Internet 20, the program proceeds to a login screen where the user enters the login identification and the corresponding password associated with the account. A trading session commences when the user successfully logs into server 50. Once the user establishes a trading session, the user gains access to all the features for the analysis and dissemination of data on electronic trading exchange 10. In a preferred embodiment, from the electronic trading exchange homepage, the user can select the full set of offers to sell or bids to buy for each of the almond varieties for which a trading book exists.

As shown in step 150, prior to placing any bids or offers, the user must set up the account preferences. This step should be executed prior to any activity on any of the electronic trading exchanges, particularly when the account is used for the first time. As shown in step 160, the user configures the company relationships between the account and any number of other member accounts. To configure the company relationships, the user selects a company from a list of member accounts. The user then chooses to add the company to its list of trading partners. Once selected, the user then defines payment terms and sets relationships with the chosen company. In an alternate embodiment, a user establishes account preferences for each almond variety for which an electronic trading exchange exists or that a user wants to access. As such, if the preferences are different for each electronic trading exchange, the display described hereafter will be different for each almond variety.

Setting company relationships is important to the trading system since all electronic trading exchanges displayed on a user's computer are color coded according to the relationships chosen for a particular company. The relationships assigned will impact how a company's offers or bids are displayed on the user's electronic trading exchange. In a preferred embodiment, the relationship can be defined as preferred, acceptable, non-preferred or no preference. Each company designated as preferred will have all bids or offers highlighted or color coded in green. Each company designated as acceptable will have all bids or offers highlighted in gray. Companies designated as unacceptable will have all bids or offers highlighted in red. If a company does not have a preference associated with it, the bid or offer will be highlighted in white. In addition, for the color coding of the electronic trading exchange to activate, at least three companies must be added to the user's list. If the minimum is not met, the electronic trading exchange will show in white. As can be appreciated, the minimum number of companies necessary to activate the electronic trading exchange can be any number and the highlighting colors can be any color combination suitable for display.

In an alternate embodiment, to further ensure the integrity of the market through anonymity, the initial changing of the company relationships may not take place for a period of time after the initial change is made by a user. For example, Company A has a preferred relationship with Company B. A representative for Company A logs into the system and views bids to buy and offers to sell. Thereafter, the representative for Company A changes the relationship with Company B to a non-preferred status. In this case, if the representative for Company A were to log out and immediately log back into the system, any posting by Company B would still be displayed as preferred until the designated time period has elapsed. The time period can be any time period necessary to ensure continued anonymity and integrity of the trading environment, such as 8 hours or 24 hours.

In an alternate embodiment, a company can be designated differently for payment terms, bids to buy and offers to sell. For example, a company could be designated unacceptable for all bids to buy and preferred for all offers to sell. As such, that company will have its bids highlighted on red and its offers highlighted in green when displayed by the user.

Payment terms are displayed when a member account views an original bid to buy or offer to sell. Payment terms selected for particular accounts assures that any offer posted will automatically assign the payment term selected. For example, the user may wish to do business with Company X on “net 30 days” terms. If the user were to make a general offer, a default term of “prepaid” may be selected. All companies that the user has not setup with payment terms will see the offer stating the “prepaid” terms. However, Company X will see the offer with the pre-selected term of “net 30 days.” In other words, offers may be customized for selected trading partners. Moreover, one of the payment terms available to the user is “Do Not Do Business With.” This term prevents the target company from countering or accepting an offer that the user has placed. The combination of the ability to customize payment terms for trading partners and to instantly distinguish preferred offers or bids through color differentiation is important to the analysis and dissemination of data in the on-line electronic trading exchange environment.

Referring again to FIG. 3, step 150 of establishing account preferences further comprises changing the user account information. If this option is selected, the account information can be changed for the company's phone number, e-mail address, contact person, U.S. Postal address and bank information to name a few. Moreover, establishing account preferences may also include changing the user password associated with the membership account login identification.

For clarity, the following description of the analysis and dissemination of data on a electronic trading exchange is divided into two sections. The first section describes displaying data for a buying operation for electronic trading exchange 10. The second section illustrates displaying data for a selling operation for electronic trading exchange 10.

Buying on the Electronic Trading Exchange

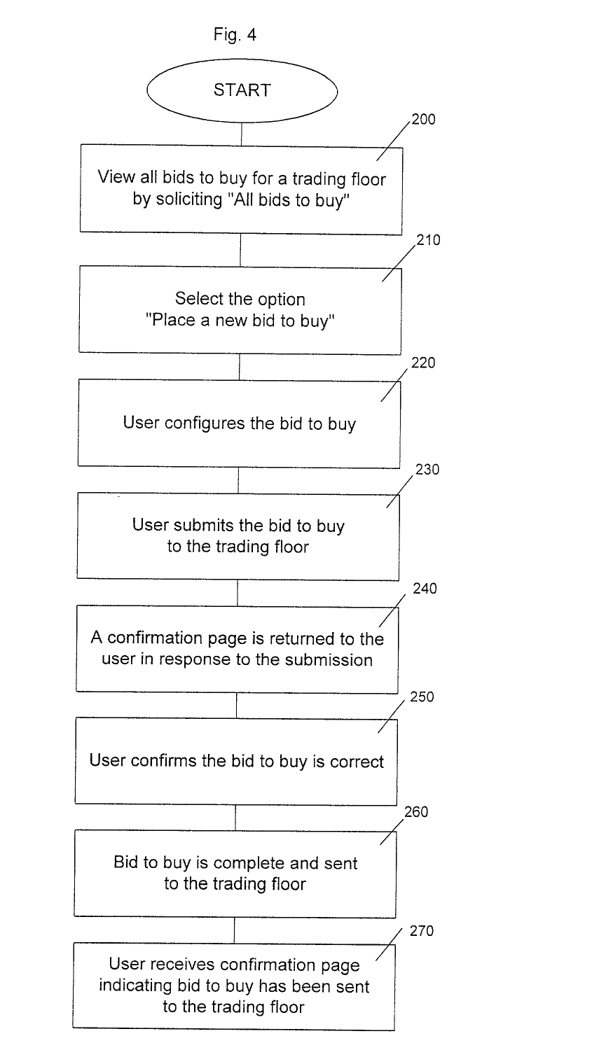

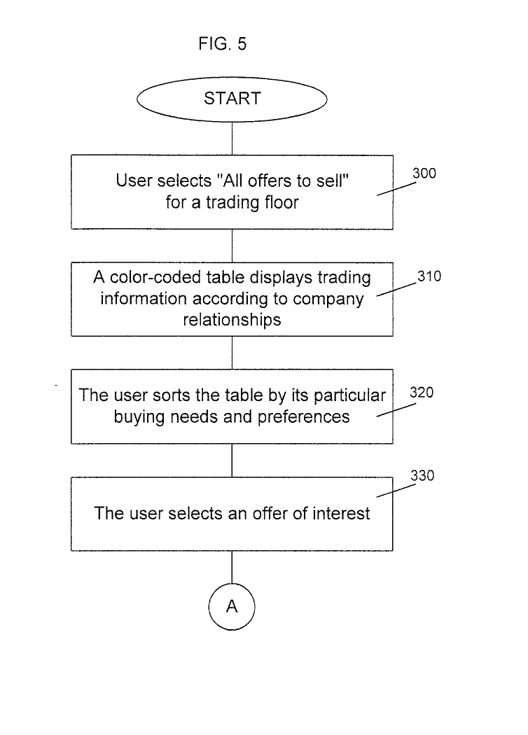

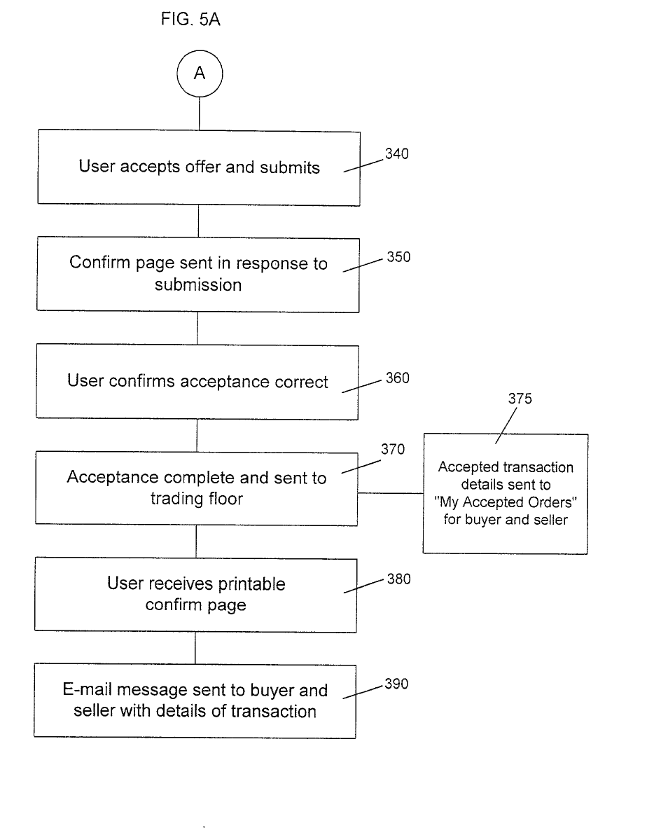

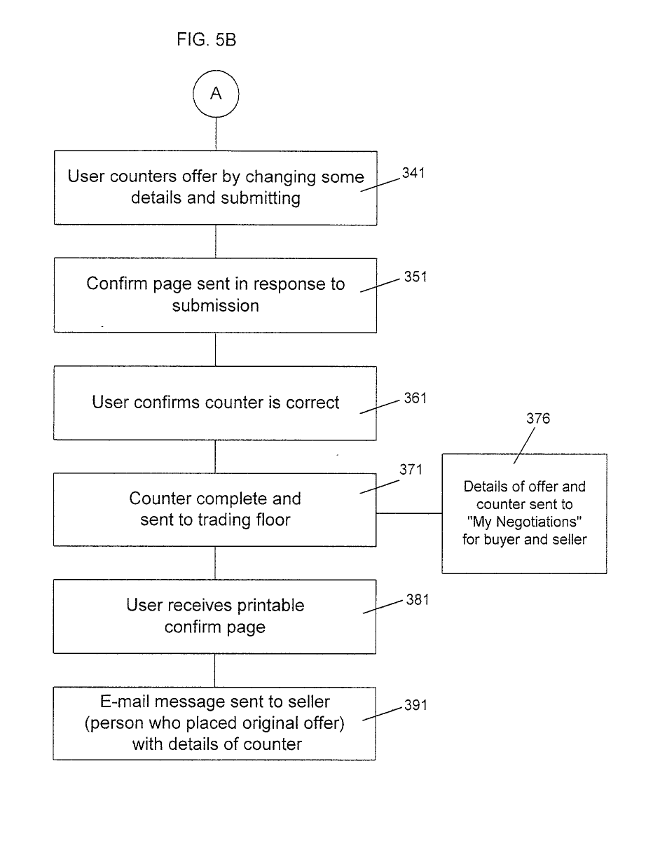

FIGS. 4, 5, 5A and 5B are flow charts describing the operation for the display of data for two buying procedures on electronic trading exchange 10. The steps are numbered sequentially and are performed in increasing order unless otherwise noted. There are two choices for buying, creating a bid to buy or viewing offers to sell. As noted previously, the invention will be described with reference to the trading of almonds, but the invention should not be limited as such in any way. Other commodities and items could be traded using the invention described herein.

The first buying option for the analysis and dissemination of data on electronic trading exchange 10 is creating a bid to buy. The steps for creating a bid to buy are illustrated in FIG. 4. As shown in step 200, in a preferred embodiment, the user views all bids to buy for the particular electronic trading exchange by selecting “All bids to buy” for the almond variety for which a trading book exists. In step 210, the user selects the option of “Place a new bid to buy” to place a bid to buy on electronic trading exchange 10.

As shown in step 220, the user configures the bid to buy based upon the many characteristics of the almond the user is looking to purchase on electronic trading exchange 10. The user can specify options, including but not limited to price per weight, quantity, packaging, crop year, grade, almond size, brand, shipment start and end dates, default payment terms, other miscellaneous terms and when the bid to buy expires.

In step 230, the user submits the bid to the electronic trading exchange 10. In step 240, once the bid is submitted to the electronic trading exchange, a confirmation page is returned that allows the user to verify all the keyed in information before the submission is confirmed. The confirmation page allows the user to examine the bid to buy carefully to ensure all the information is correct prior to submission to electronic trading exchange 10. When the user is satisfied that the bid to buy is correct, as shown in step 250, the submission is confirmed. In step 260, the bid to buy is complete and is sent to the electronic trading exchange 10. In step 270, the user receives a confirmation page indicating the bid to buy has been sent to electronic trading exchange 10.

The second buying option for the analysis and dissemination of data on electronic trading exchange 10 is viewing offers to sell. The steps for viewing an offer to sell are illustrated in FIGS. 5, 5A and 5B. As shown in step 300, in a preferred embodiment, the user selects “All offers to sell” for the electronic trading exchange the user wants to view. As shown in step 310, a color-coded table displays trading information based upon the selected electronic trading exchange and the previously established company relationships. For example, if a company was defined as a preferred trading partner, the company's offer to sell is highlighted in green. An important aspect of the color-coded table is the absence of company names corresponding to the offers to sell. Although the color identifies whether an offer to sell is preferred, acceptable, unacceptable or no preference, the color-coding does not identify the company making the offer. Maintaining the anonymity of the seller helps maintain the integrity of electronic trading exchange 10 by reducing the chance of manipulating the trading environment.

As shown in step 320, the color-coded table can be sorted by color of the offers to sell, price, quantity, grade, size, crop year, shipment date or expiration date. Sorting allows the user to view the table according to particular buying needs and preferences.

In step 330, the user selects an offer to sell that is of interest. The offer to sell is displayed with all the information associated with the offer, including but not limited to price, quantity, packaging, crop year, grade, size, brand, shipment start and end date, shipping terms, payment terms, miscellaneous terms, expiration date for the offer and total contract price.

FIG. 5A illustrates the steps for accepting an offer. As shown in step 340, after reviewing the offer to sell, the user may accept the offer as posted. As shown in step 350, if the user accepts the offer, a confirmation page is displayed that allows the user to verify all the information in the acceptance before submission. When the user is satisfied that all terms are acceptable, as shown in step 360, the user confirms that the terms of the acceptance are correct. The acceptance is submitted to electronic trading exchange 10 as shown in step 370. As shown in step 375, the details of the accepted transaction are sent to a storage area for both the buyer and the seller. In the illustrated embodiment, this area is defined as “My Accepted Orders” and can be easily viewed. In step 380, the user receives a printable confirmation page. In step 390, upon completion of the sale, both the buyer and seller are notified by e-mail of the terms and details of the transaction.

FIG. 5B illustrates the steps for countering of an offer. As shown in step 341, after reviewing an offer to sell, the user may change some of the details for an offer and submit the changes to the electronic trading exchange. As shown in step 351, if the user counters an offer, a confirmation page is displayed that allows the user to verify all the information in the acceptance before submission. When the user is satisfied that all terms are acceptable, as shown in step 361, the user confirms that the terms of the counteroffer are correct. The counteroffer is submitted to electronic trading exchange 10 as shown in step 371. As shown in step 376, the details of the offer and counteroffer are sent to a storage area for both the buyer and the seller. In the illustrated embodiment, this area is defined as “My Negotiations” and can be easily retrieved and viewed. In step 381, the user receives a printable confirmation page. In step 391, the seller is notified by e-mail of the terms and details of the counteroffer.

Selling on the Electronic trading exchange

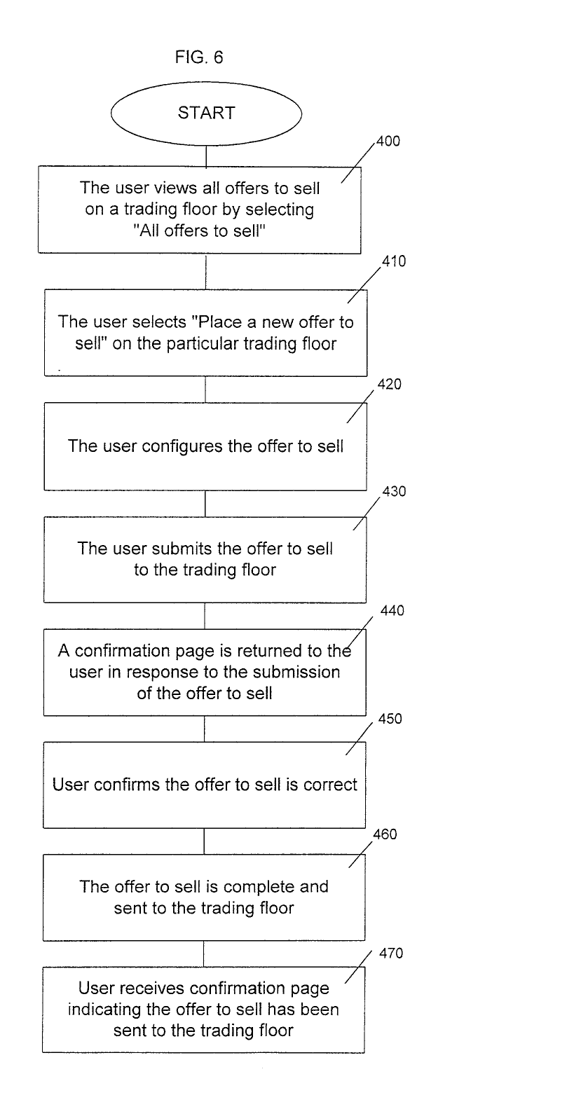

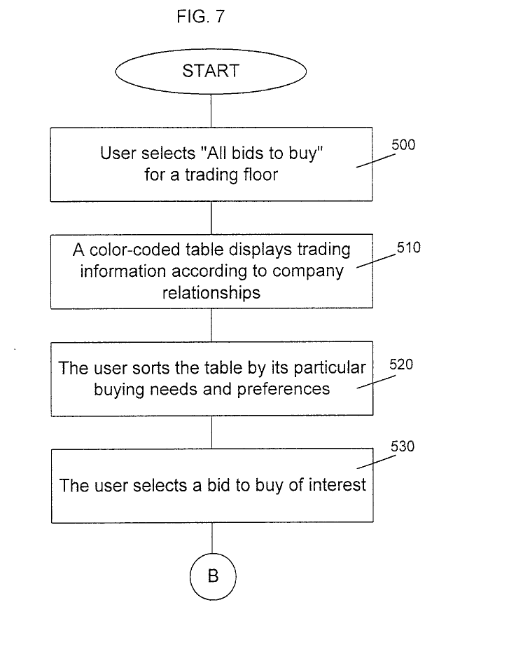

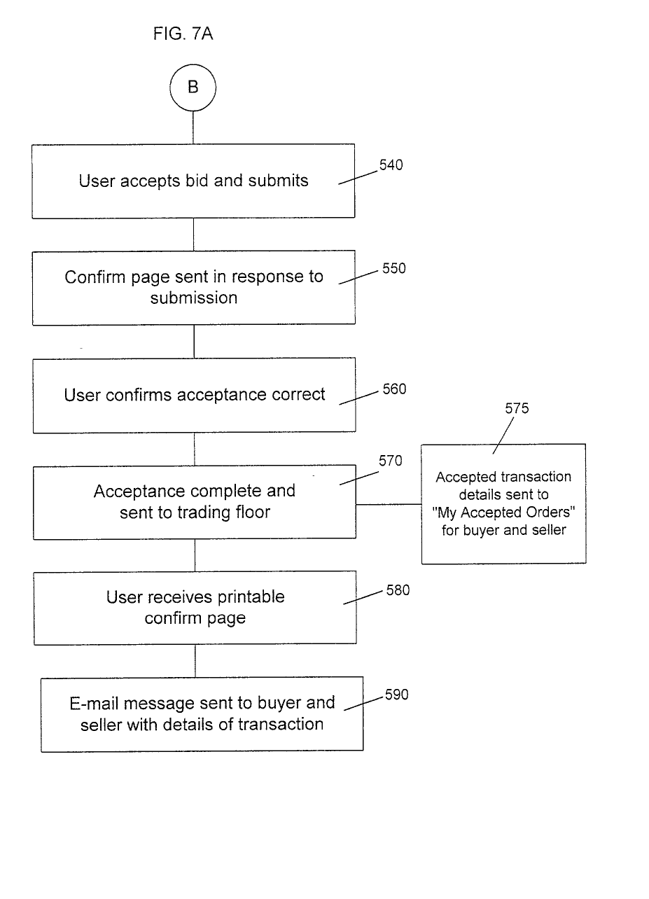

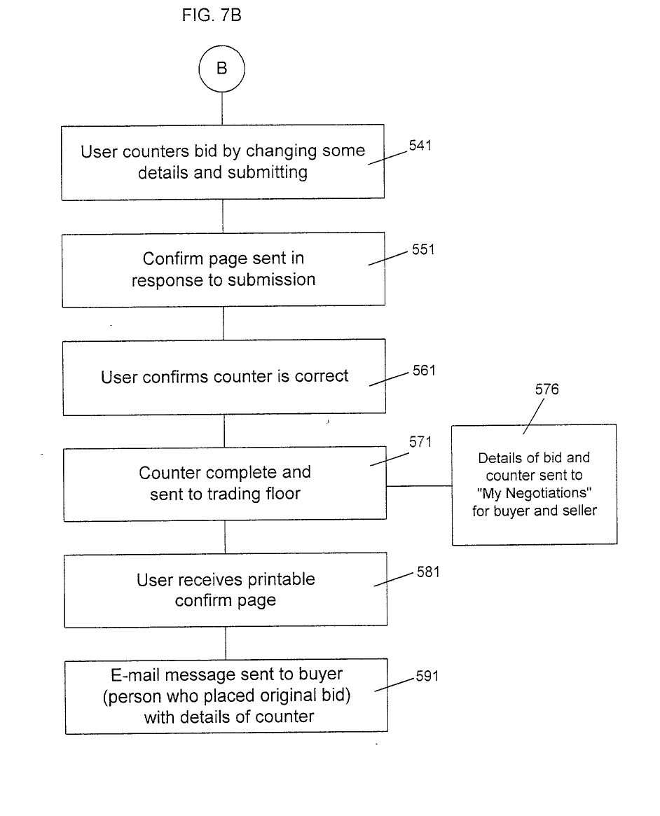

FIGS. 6, 7, 7A and 7B are flow charts describing the operation for the display of data for the two selling procedures on the electronic trading exchange 10. The steps are numbered sequentially and are performed in increasing order unless otherwise noted. There are two choices for selling, creating an offer to sell or viewing bids to buy. As noted previously under the section for buying on the electronic trading exchange, the invention will be described with reference to the trading of almonds, but the invention should not be limited as such in any way.

The first selling option for the analysis and dissemination of data on electronic trading exchange 10 is creating an offer to sell. The steps for creating an offer to sell are illustrated in FIG. 6. As shown in step 400, in a preferred embodiment, the user views all offers to sell for the particular electronic trading exchange by selecting “All offers to sell” for the almond variety for which a trading book exists. In step 410, the user selects the option of “Place a new offer to sell” to place an offer to sell on electronic trading exchange 10.

As shown in step 420, the user configures the offer to sell based upon the many characteristics of the almond the user is selling on electronic trading exchange 10. The user can specify options, including but not limited to price per weight, quantity, packaging, crop year, grade, almond size, brand, shipment start and end dates, shipping terms, default payment terms, other miscellaneous terms and when the offer to sell expires.

In step 430, the user submits the offer to the electronic trading exchange 10. In step 440, once the offer is submitted to the electronic trading exchange 10, a confirmation page is returned that allows the user to verify all the keyed in information before the submission is confirmed. The confirmation page allows the user to examine the offer to sell carefully to ensure all the information is correct prior to submission to electronic trading exchange 10. When the user is satisfied the offer to sell is correct, as shown in step 460, the submission is confirmed. The offer to sell is complete and is soon thereafter sent to the electronic trading exchange 10. In step 470, the user receives a confirmation page indicating the offer to sell has been sent to electronic trading exchange 10.

The second selling option for the analysis and dissemination of data on electronic trading exchange 10 is viewing bids to buy. The steps for viewing a bid to buy are illustrated in FIGS. 7, 7A and 7B. As shown in step 500, in a preferred embodiment, the user selects “All bids to buy” for the electronic trading exchange the user wants to view. As shown in step 510, a color-coded table displays trading information based upon the selected electronic trading exchange and the previously established company relationships. For example, if a company was defined as a preferred trading partner, the company's bid to buy is highlighted in green. An important aspect of the color-coded table is the absence of company names corresponding to the bid to buy. Although the color identifies whether a bid to buy is preferred, acceptable, unacceptable or no preference, the color-coding does not identify the company making the offer. Maintaining the anonymity of the seller helps maintain the integrity of electronic trading exchange 10 by reducing the chance of manipulating the trading environment.

As shown in step 520, the color-coded table can be sorted by color of the bid to buy, price, quantity, grade, size, crop year, shipment date or expiration date. Sorting allows the user to view the table according to particular selling needs and preferences.

In step 530, the user selects a bid to buy that is of interest. The bid to buy will be displayed with all the information associated with the bid, including but not limited to price, quantity, packaging, crop year, grade, size, brand, shipment start and end date, shipping terms, payment terms, miscellaneous terms, expiration date for the bid and total contract price.

FIG. 7A illustrates the steps for accepting a bid to buy. As shown in step 540, after reviewing the bid to buy, the user may accept the bid as posted. As shown in step 550, if the user accepts the bid, a confirmation page is displayed that allows the user to verify all the information in the acceptance before submission. When the user is satisfied that all terms are acceptable, as shown in step 560, the user confirms the acceptance is correct. As shown in step 570, the acceptance is submitted to electronic trading exchange 10. As shown in step 575, the details of the accepted transaction are sent to a storage area for both the buyer and the seller. In the illustrated embodiment, this area is defined as “My Accepted Orders” and is easily accessed and viewed. In step 580, the user receives a printable confirmation page. In step 590, upon completion of the sale, both the buyer and seller are notified by e-mail of the terms and details of the transaction.

FIG. 7B illustrates the steps for countering a bid to buy. As shown in step 541, after reviewing the bid to buy, the user may change some of the details of the bid and submit to electronic trading exchange 10. As shown in step 551, if the user counters the bid, a confirmation page is displayed that allows the user to verify all the information in the acceptance before submission. When the user is satisfied that all terms are acceptable, as shown in step 561, the user confirms the counter bid is correct. As shown in step 571, the counter bid is submitted to electronic trading exchange 10. As shown in step 575, the details of the bid and counter bid are sent to a storage area for both the buyer and the seller. In the illustrated embodiment, this area is defined as “My Negotiations” and is easily accessed and viewed. In step 581, the user receives a printable confirmation page. In step 591, the buyer is notified by e-mail of the terms and details of the counter bid.

Reviewing Transactions

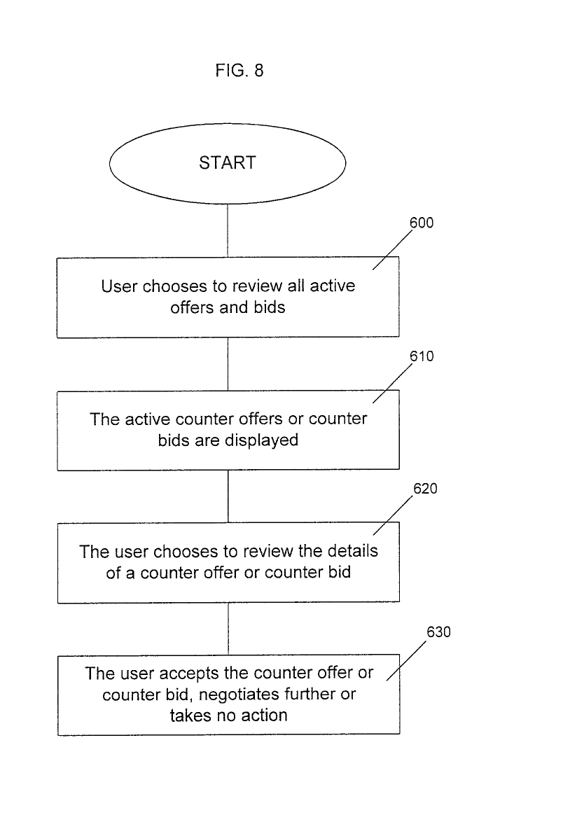

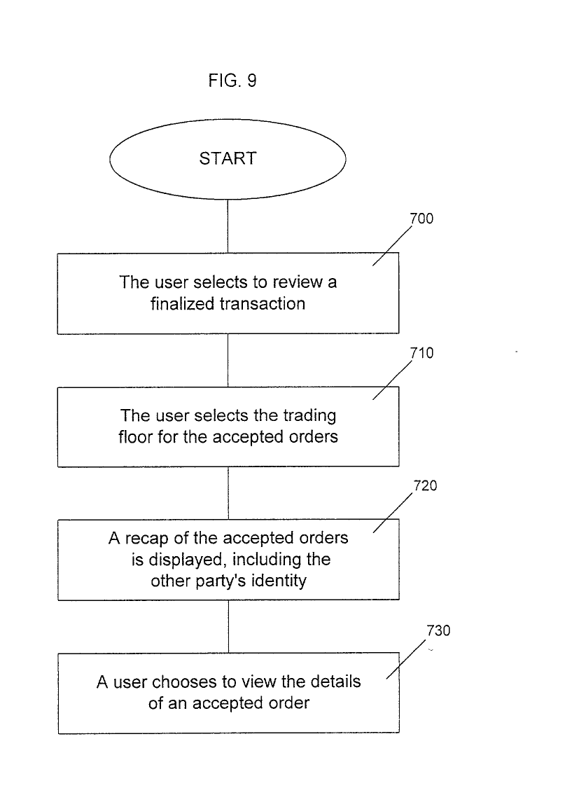

FIGS. 8 and 9 are flow charts for two reviewing procedures available to a user, specifically, reviewing open negotiations and reviewing concluded transactions on electronic trading exchange 10. In a preferred embodiment, the reviewing procedures are available at any time in the trading system by choosing a menu item that links to the respective reviewing area. For example, the user may chose an option labeled “My negotiations” or “My accepted orders” to review open negotiations and closed transactions respectively.

FIG. 8 illustrates the review open negotiations option. As shown in step 600, the user can choose to review any transaction, either an offer or a bid, that is currently active. Not only does the review display offers and bids, but also any counter offers or counter bids that are active. The counters include both those counters that are active against the user and those counters that the user has placed against another member accounts.

In step 610, the active counters awaiting action are readily indicated, for example, by a red arrow. In step 620, the user can review the details of a counter. The differences between the original bid or offer are highlighted. The highlighting of the differences facilitates quick analysis. In step 630, the user can accept the counter bid or offer or negotiate further, which is identical to the steps listed above for selling and buying.

FIG. 9 illustrates the review closed transactions option. As shown in step 700, the user can select to review any transaction that has been finalized. A finalized transaction is a buy or a sell order that has been accepted by both parties. In step 710, the user selects the electronic trading exchange for the accepted orders to view. As shown in step 720, a recap is displayed for all accepted orders, including the identity of the other party to the transaction. It should be-noted that this is the only time a seller's identity will be revealed. In step 730, the user can choose to view the full details of the transaction. From the detailed display, the user may chose to send an e-mail to the other party by selecting the company's name.

The above description is illustrative and not restrictive. Many variations of the invention will become apparent to those of skill in the art upon review of this disclosure. For example, although the preferred embodiment has been described in terms of almond trading, the disclosed invention would work well for any type of good or commodity. The scope of the invention should, therefore, be determined not with reference to the above description, but instead should be determined with reference to the appended claims along with the full scope of equivalents.

What is claimed is:

1. A method for implementing a display for an on-line electronic trading exchange, said method comprising the steps of:
providing access to at least two users to an interactive computer system;
establishing a first one of a plurality of member accounts using said interactive computer system, each member account having a unique identification and password;
defining account preferences further comprising:
defining default payment terms; and
defining a trading relationship between said first one of a plurality of member accounts and at least one other of said plurality of member accounts;
selecting an electronic trading exchange comprising at least one offer to sell; and
viewing a table wherein all offers to sell are identified according to said trading relationship.

2. The method of claim 1, further comprising the step of viewing a table wherein all offers to sell are color-coded according to said trading relationship.

3. The method of claim 1, further comprising the step of defining a plurality of trading relationships between said first one of a plurality of member accounts and several of said plurality of member accounts.

4. The method of claim 1, further comprising the steps of:
selecting an offer to sell;
reviewing said offer to sell;
accepting said offer to sell;
verifying said offer to sell and corresponding terms;
confirming said offer to sell; and
notifying the buyer and the seller of the terms of the transaction.

5. The method of claim 4, wherein said step of notifying further comprises automatically notifying the buyer and seller of the terms of the transaction by electronic mail.

6. The method of claim 1, further comprising the steps of:
selecting an offer to sell;
reviewing said offer to sell;
countering said offer to sell; and
notifying the buyer and the seller of the terms of the transaction.

7. The method of claim 6, wherein said step of notifying further comprises automatically notifying the buyer and seller of the terms of the transaction by electronic mail.

8. The method of claim 1, further comprising the steps of:
selecting an option within said electronic trading exchange corresponding to placing an offer to sell;
configuring and submitting said offer to sell;
verifying said offer to sell; and
confirming said offer to sell.

9. The method of claim 1, wherein said step of defining default payment terms further comprises defining a special payment term for a second one of a plurality of member accounts such that said special payment term is displayed, using a computer, for said second one of a plurality of member accounts only instead of said default payment term.

10. The method of claim 9, wherein said special payment term comprises a first term, wherein said first term defines that said second one of a plurality of member accounts cannot accept or counter any bid or offer posted by said first one of a plurality of member accounts.

11. The method of claim 10, wherein said first term is a do not do business with term.

12. The method of claim 1, wherein said trading relationship is chosen from a group consisting of a preferred relationship, an acceptable relationship, a non-preferred relationship, and a non-specified relationship.

13. The method of claim 12, wherein all offers to sell having a preferred relationship are color coded a first color, all offers to sell having an acceptable relationship are color coded a second color, all offers to sell having a non-preferred relationship are color coded a third color and all offers to sell having a non-specified relationship are color coded a fourth color.

14. The method of claim 13, wherein at least three of said plurality of member accounts must be chosen for each trading relationship or all offers to sell are color coded with said fourth color.

15. The method of claim 13, wherein any change made to said trading relationship does not take effect for a period of time.

16. The method of claim 15, wherein said period of time is 8 hours.

17. A method for implementing a display for an on-line electronic trading exchange, said method comprising the steps of:
providing an Internet webpage accessible to at least two users, via a computer system, for on-line interactive communication between said users and said Internet webpage;
establishing a first one of a plurality of member accounts using said Internet web page, each member account having a unique identification and password;
defining account preferences further comprising:
defining default payment terms; and
defining a trading relationship between said first one of a plurality of member accounts and at least one other of said plurality of member accounts;
selecting an electronic trading exchange comprising at least one bid to buy; and
viewing a table wherein all bids to buy are identified according to said trading relationship.

18. The method of claim 17, further comprising the step of viewing a table wherein all bids to buy are color-coded according to said trading relationship.

19. The method of claim 17, further comprising the step of defining a plurality of trading relationships between said first one of a plurality of member accounts and several of said plurality of member accounts.

20. The method of claim 17, further comprising the steps of:
selecting a bid to buy;
reviewing said bid to buy;
accepting said bid to buy;
verifying said bid to buy and the corresponding terms;
confirming said bid to buy; and
notifying the buyer and the seller of the terms of the transaction.

21. The method of claim 20, wherein said step of notifying further comprises notifying the buyer and seller of the terms of the transaction and terms by electronic mail.

22. The method of claim 17, further comprising the steps of:
selecting a bid to buy;
reviewing said bid to buy;
countering said bid to buy; and
notifying the buyer and the seller of the terms of the transaction.

23. The method of claim 22, wherein said step of notifying further comprises notifying the buyer and seller of the terms of the transaction and terms by electronic mail.

24. The method of claim 17, further comprising the steps of:
selecting an option within said electronic trading exchange corresponding to placing a bid to buy;
configuring and submitting said bid to buy;
verifying said bid to buy; and
confirming said bid to buy.

25. The method of claim 17, wherein said step of defining default payment terms further comprises defining a special payment term for a second one of a plurality of member accounts such that said special payment term is displayed, using a computer, for said second one of a plurality of member accounts only instead of said default payment term.

26. The method of claim 25, wherein said special payment term comprises a first term, wherein said first term defines that said second one of a plurality of member accounts cannot accept or counter any bid or offer posted by said first one of a plurality of member accounts

27. The method of claim 26, wherein said first term is a do not do business with term.

28. The method of claim 17, wherein said trading relationship is chosen from a group consisting of a preferred relationship, an acceptable relationship, a non-preferred relationship, and a non-specified relationship.

29. The method of claim 28, wherein all offers to sell having a preferred relationship are color coded a first color, all offers to sell having an acceptable relationship are color coded a second color, all offers to sell having a non-preferred relationship are color coded a third color and all offers to sell having a non-specified relationship are color coded a fourth color.

30. The method of claim 29, wherein at least three member accounts must be chosen for each trading relationship specified or all offers to sell are color coded with said fourth color.

31. The method of claim 29, wherein any change made to said trading relationship does not take effect for a period of time.

32. The method of claim 31, wherein said period of time is 8 hours.

33. A method for providing analysis and dissemination of data for trading on-line between buyers and sellers on an electronic trading exchange, comprising:
providing an Internet webpage accessible to at least two users, via a computer system, for on-line interactive communication between said users and said Internet webpage;
establishing a first one of a plurality of member accounts using said Internet web page, each member account having a unique identification and password;
defining account preferences further comprising:
defining default payment terms; and
defining a trading relationship between said first one of a plurality of member accounts and at least one other of said plurality of member accounts;
displaying, using a computer, at least one offer to sell in a table; and
maintaining the anonymity of the seller placing the offer to sell, while displaying, using a computer, the account preferences and offer information in said table.

34. The method of claim 33, further comprising the steps of color coding said trading relationship and displaying said color coding in said table such that said first one of a plurality of member accounts can quickly identify said trading relationship.

35. A computer system for implementing a display for an on-line electronic trading exchange, said computer system comprising:
software for providing an Internet webpage accessible to at least two users, via said computer system, for on-line interactive communication between said users and said Internet webpage;
software for establishing a first one of a plurality of member accounts using said Internet web page, each member account having a unique identification and password, for defining account preferences further comprising defining default payment terms and defining a trading relationship between said first one of a plurality of member accounts and at least one other of said plurality of member accounts; and
software for selecting an electronic trading exchange comprising at least one offer to sell, and for displaying a table wherein all offers to sell are color-coded according to said trading relationship.

36. A computer system for implementing a display for an on-line electronic trading exchange, said computer system comprising:
software for providing an Internet webpage accessible to at least two users, via said computer system, for on-line interactive communication between said users and said Internet webpage;
software for establishing a first one of a plurality of member accounts using said Internet web page, each member account having a unique identification and password, for defining account preferences further comprising defining default payment terms and defining a trading relationship between said first one of a plurality of member accounts and at least one other of said plurality of member accounts; and
software for selecting an electronic trading exchange comprising at least one bid to buy, and for displaying a table wherein all bids to buy are color-coded according to said trading relationship.
